(19) United States
(12) Patent Application Publication
(10) Pub. No.: US 2007/0165950 A1
(43) Pub. Date: Jul. 19, 2007

(54) Image processing apparatus, image processing method, and computer program product

(76) Inventor: Hirobumi Nishida, Kanagawa (JP)

Correspondence Address: DICKSTEIN SHAPIRO LLP, 1825 EYE STREET NW, Washington, DC, 20006-5403, US

(21) Appl. No.: 11/639,215

(22) Filed: Dec. 15, 2006

(30) Foreign Application Priority Data
Jan. 18, 2006 (JP) 2006-010368

(51) Int. Cl. G06K 9/34

(52) U.S. Cl. 382/177

(57) ABSTRACT

Image data is classified to identify the type of the image data using a feature amount of the image data calculated based on the layout (rough spatial arrangement and distribution of texts and photographs or pictures). Based on the result, a region extraction method that is associated with the type of the image data is selected for layout analysis. According to the region extraction method, the image data is divided into regions.

### CROSS-REFERENCE TO RELATED APPLICATIONS

The present document incorporates by reference the entire contents of Japanese priority document, 2006-010368 filed in Japan on Jan. 18, 2006.

### BACKGROUND OF THE INVENTION

1. Field of the Invention

The present invention relates to a technology for analyzing image layout.

2. Description of the Related Art

An image is input to a computer through an image input device such as a scanner or a digital camera, and the image is separated into components such as a character, a text line, a paragraph, and a column. This process is generally called “geometric layout analysis” or “page segmentation”. The geometric layout analysis or the page segmentation is in many cases implemented on a binary image. Besides, the geometric layout analysis or the page segmentation is followed by “skew correction”, as preprocessing, for correcting a skew occurring upon input. The geometric layout analysis or the page segmentation of the binary image subjected to skew correction in this manner is roughly classified into two approaches, i.e., top-down analysis and bottom-up analysis.

The top-down analysis is implemented by dividing a page from a large component into small components. This analysis is an approach in which a large component is divided into small components in such a manner that the page is divided into columns, each of the columns into paragraphs, and each of the paragraphs into text lines. The top-down analysis allows efficient calculation by using a model (for example, the text lines are rectangular or in a column shape in Manhattan layout) based on an assumption for a page layout structure. At the same time, the top-down analysis has disadvantages such that an unexpected error may occur when data is not based on the assumption. For a complex layout, modeling is generally complicated, and accordingly, handling is difficult.

Then, the bottom-up analysis is explained below. As described in Japanese Patent Application Laid-Open Nos. 2000-067158 and 2000-113103, the bottom-up analysis starts by merging components together by referring to a positional relationship between adjacent components. This analysis is an approach that groups smaller components to form a larger component in such a manner that connected components are grouped into a text line, and text lines are grouped into a column. The conventional bottom-up analysis, however, is based on pieces of local information, and therefore, the method can support a variety of layouts without much dependence on the assumption for the whole-page layout, but has disadvantages such that local miscalculations may be accumulated. For example, if two characters across two different columns are erroneously merged into one text line, these two different columns may erroneously be extracted as one column. The conventional technology that merges components requires knowledge such as characteristics of how to align characters and a character-string direction (vertical/horizontal) based on each language.

As explained above, these two approaches are complimentary, but as an approach bridging “gap” between these two, there is a method of using a non-character portion, i.e., background or so-called white background, in a binary image, as disclosed in U.S. Pat. No. 5,647,021 and U.S. Pat. No. 5,430,808. Advantages of using the background or the white background are as follows:

(1) The method is language-independent (the white background is used as a separator in many languages). Moreover, there is no need for knowledge about a text line direction (horizontal writing/vertical writing).

(2) The method is an overall process, and therefore, there is less possibility of accumulating local miscalculations.

(3) The method can flexibly support even complex layouts.

The advantages and disadvantages of the approaches, and the image types well-handled or not-well-handled by the respective approaches are summarized as follows:

(1) Advantages

In the bottom-up type, the approach can exhibit performance to some-extent for any layout. This is a building-up type process such as “character→character string→text line→text block”, and hence, no model for a layout structure is needed.

In the top-down type, the approach demonstrates its strong point when information dependent on a model for the layout structure can be used. Because overall information can be used, local errors are not accumulated. Moreover, the top-down type can implement language-independent analysis.

(2) Disadvantages

In the bottom-up type, local miscalculations are accumulated. Language dependency is inevitable for characters, character strings, and the structure of text lines.

In the top-down type, the approach does not work well when an assumed model is not appropriate.

(3) Image Types Well-Handled

The bottom-up type is good at images with a few texts. Local errors hardly occur, and because there are a few texts, only a small amount of calculation is required for merging them.

The top-down type is good at documents (newspapers, articles of magazines, business documents) in which characters are dominant and an arrangement of columns is structured.

(4) Image Types Not-Well-Handled

The bottom-up type is not good at those in which layouts are densely arranged (newspapers etc.), because local errors may easily occur.

The top-down type is not good at those in which pictures are dominant (sport newspapers, advertisements) or those in which an arrangement of columns is not structured.

As can be seen, the bottom-up-type layout analysis and the top-down-type layout analysis are complementary, and there are several types of algorithms of the layout analysis only for extraction of a text region.

More specifically, there are image types which these two approaches are good at or not good at depending on the types of images. Therefore, it is desired that an appropriate algorithm be used depending on the type of an image. This seems a simple idea, but actually, this is quite complicated because the type of the image can not be found out until regions are discriminated from each other. In other words, the region discrimination needed for type classification requires highly expressive image features allowing high-speed calculation.

### SUMMARY OF THE INVENTION

It is an object of the present invention to at least partially solve the problems in the conventional technology.

According to an aspect of the present invention, an image processing apparatus that analyzes layout, of an image, includes an image-feature calculating unit that calculates a feature amount of image data based on layout of the image, an image-type identifying unit that identifies an image type of the image data using the image feature amount, a storage unit that stores therein information on image types each associated with a region extraction method, a selecting unit that refers to the information in the storage unit to select for layout analysis a region extraction method associated with the image type of the image data, and a region extracting unit that divides the image data into regions based on the region extraction method.

According to another aspect of the present invention, an image processing method for analyzing image layout, includes calculating a feature amount of image data based on layout of an image, identifying an image type of the image data using the image feature amount, storing information on image types each associated with a region extraction method, referring to the information to select for layout analysis a region extraction method associated with the image type of the image data, and dividing the image data into regions based on the region extraction method.

According to still another aspect of the present invention, a computer program product comprising a computer usable medium having computer readable program codes embodied in the medium that when executed causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining electrical connection in an image processing apparatus according to a first embodiment of the present invention;

FIG. 2 is a functional block diagram of the image processing apparatus that performs a layout analyzing process implemented by a CPU shown in FIG. 1;

FIG. 3 is a schematic flowchart of the layout analyzing process;

FIG. 4 is a schematic flowchart of an image-feature-amount calculating process performed by an image-feature-amount calculating unit shown in FIG. 2;

FIG. 5 is a schematic flowchart of a block classifying process;

FIG. 6 is a schematic for explaining a multiresolution process;

FIG. 7 is examples of mask patterns for calculating a higher-order autocorrelation function;

FIGS. 8A to 8F are schematics of examples of block classification;

FIG. 9 is a flowchart of an example of region-extraction-method selection based on image types;

FIG. 10 is a schematic for explaining a basic approach of the layout analyzing process based on a top-down-type region extraction method;

FIGS. 11A and 11B are schematics for explaining a result of region extraction for an image of FIG. 8B;

FIG. 12 is an external perspective view of a digital multifunction product (MFP) according to a second embodiment of the present invention; and

FIG. 13 is a schematic of a server-client system according to a third embodiment of the present invention.

### DETAILED DESCRIPTION OF THE PREFERRED EMBODIMENTS

Exemplary embodiments of the present invention are explained in detail below with reference to the accompanying drawings.

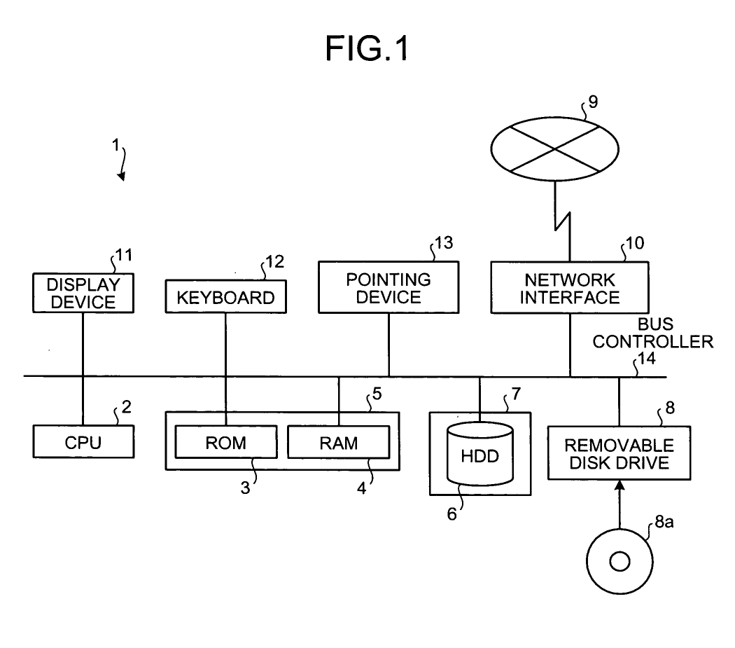

FIG. 1 is a schematic for explaining electrical connection in an image processing apparatus 1 according to a first embodiment of the present invention. The image processing apparatus 1 is a computer such as a personal computer (PC). The image processing apparatus 1 includes a Central Processing Unit (CPU) 2 that controls components of the image processing apparatus 1, a primary storage device 5 such as Read Only Memory (ROM) 3 and Random Access Memory (RAM) 4 for storing information, a secondary storage device 7 such as a hard disk drive (HDD) 6 for storing a data file (e.g., color bitmap image data), a removable disk drive 8 such as a Compact Disk Read Only Memory (CD-ROM) drive for storing information, distributing information to external devices, and acquiring information from an external device. The image processing apparatus 1 further includes a network interface 10 for communicating information with another computer via a network 9, a display device 11 such as a Cathode Ray Tube (CRT) or a Liquid Crystal Display (LCD) for informing an operator of progress of processes and results, a keyboard 12 used when the operator enters an instruction and information to the CPU 2, and a pointing device 13 such as a mouse. A bus controller 14 arbitrates data to be transmitted/received between the components for operation.

The first embodiment is explained using, but not limited to, an ordinary PC as the image processing apparatus 1. The image processing apparatus 1 can be a portable information terminal called Personal Digital Assistants (PDA), palmTop PC, a mobile telephone, Personal Handyphone System (PHS).

In the image processing apparatus 1, when a user turns the power on, the CPU 2 starts executing a program called loader in the ROM 3, and loads a program that controls hardware and software of the computer called operating system from the HDD 6 into the RAM 4 to start the operating system. The operating system starts a program according to an operation by the user, loads information, and stores the information. Windows (TM) and UNIX (TM) are known as typical operating systems. An operating program running on the operating systems is called application program.

The image processing apparatus 1 stores an image processing program as the application program in the HDD 6. The HDD 6 in this sense serves as a storage medium that stores the image processing program.

Generally, an application program to be installed into the secondary storage device 7 such as the HDD 6 of the image processing apparatus 1 is recorded on a storage medium 8a including optical information recording media such as CD-ROM and Digital Versatile Disk Read Only Memory (DVD-ROM) or magnetic media such as a Floppy Disk (FD). The application program recorded on the storage medium 8a is installed in the secondary storage device 7 such as the HDD 6. Therefore, the storage medium 8a including the optical information recording media such as CD-ROM and DVD-ROM or the magnetic media such as FD having portability can also be a storage medium for storing the image processing program. The image processing program can be stored in a computer connected to a network such as the Internet, downloaded therefrom via the network interface 10, and installed into the secondary storage device 7 such as the HDD 6. The image processing program can also be provided or distributed through the network such as the Internet.

When the image processing program running on the operating system is started in the image processing apparatus 1, the CPU 2 executes various types of computing processes according to the image processing program, and controls overall operation of the components. A layout analyzing process, which is characteristic in the first embodiment among the computing processes executed by the CPU 2, is explained below.

Incidentally, if real time performance is emphasized, the process needs to be speeded up. To do so, it is desired that logical circuits (not shown) are separately provided and various computing processes are executed by operations of the logical circuits.

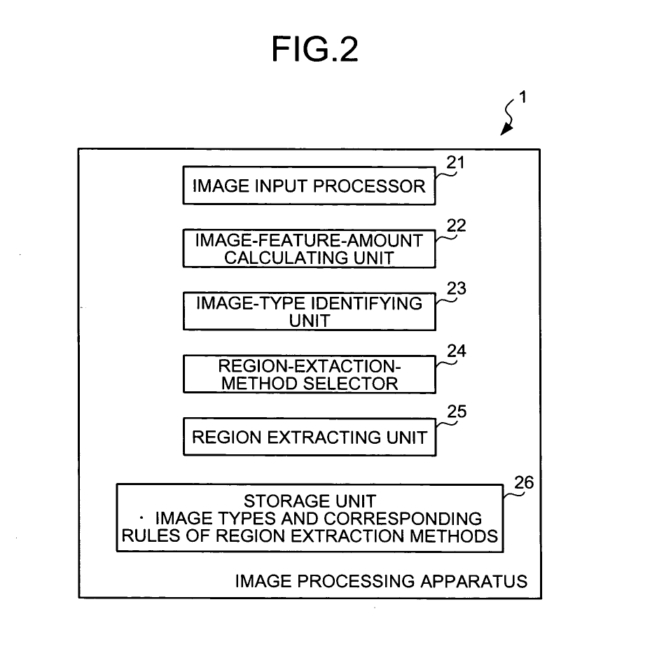

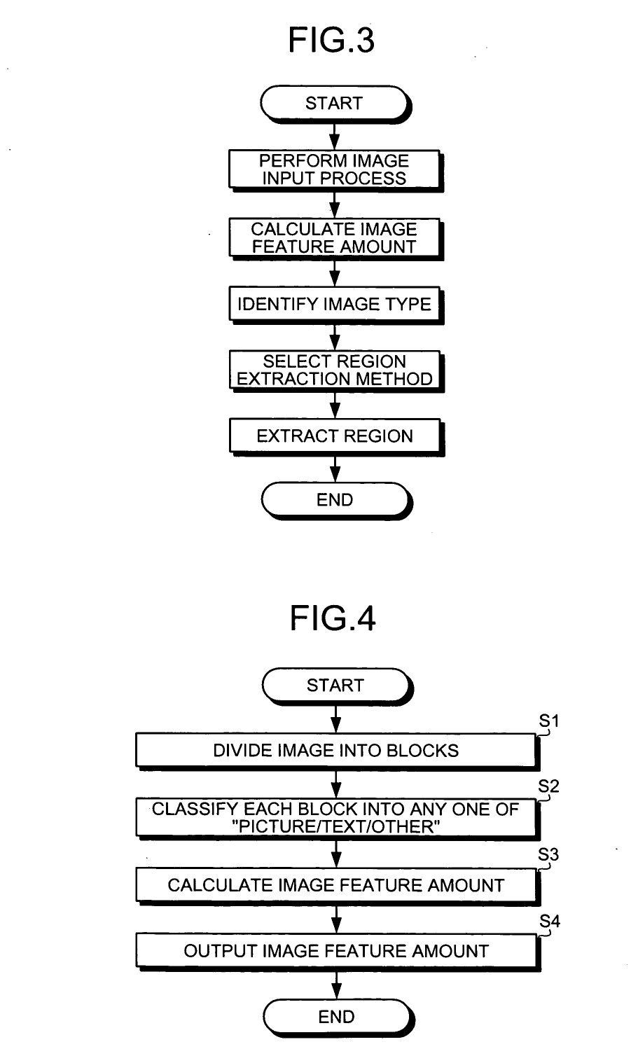

FIG. 2 is a functional block diagram of the image processing apparatus 1 for performing the layout analyzing process implemented by the CPU 2. FIG. 3 is a schematic flowchart of the layout analyzing process. The image processing apparatus 1 includes an image input processor 21, an image-feature-amount calculating unit 22, an image-type identifying unit 23, a region-extraction-method selector 24, a region extracting unit 25, and a storage unit 26. The operations and functions of the respective units are explained below.

The image input processor 21 performs skew correction of an image input, or performs preprocessing for an image when a color image is input. Specifically, the skew correction corrects skew in the image, and the preprocessing is such that the image is converted to a monochrome gray-scale image.

The image-feature-amount calculating unit 22 outputs feature amounts of the whole image. FIG. 4 is a schematic flowchart of an image-feature-amount calculating process performed by the image-feature-amount calculating unit 22. First, an image input is exclusively divided into rectangular or square blocks of the same size (step S1: a block dividing unit), and each of the blocks is classified into any one of three types of “picture”, “text”, and “other” (step S2: a block classifying unit). Then, image feature amounts of the entire image are calculated based on the results of classification of all the blocks (step S3: a calculating unit). Lastly, the image feature amounts of the entire image are output (step S4). The operations of steps are explained below.

(1) Division into Blocks (Step S1)

The input image is divided into blocks of the same size such as squares of, for example, 1 cm×1 cm (if resolution is 200 dpi, 80 pixels×80 pixels, and if resolution is 300 dpi, 120 pixels×120 pixels).

(2) Classification of Blocks (Step S2)

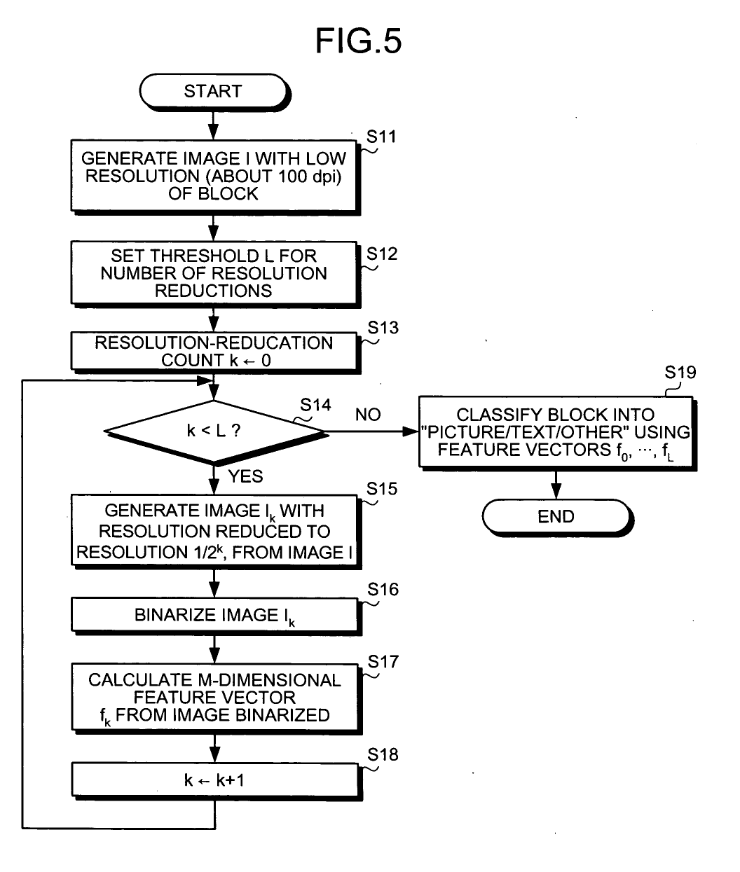

Each of the blocks is classified into any one of the three types of “picture”, “text”, and “other”. The flow of this process is shown in FIG. 5, and details thereof are explained below.

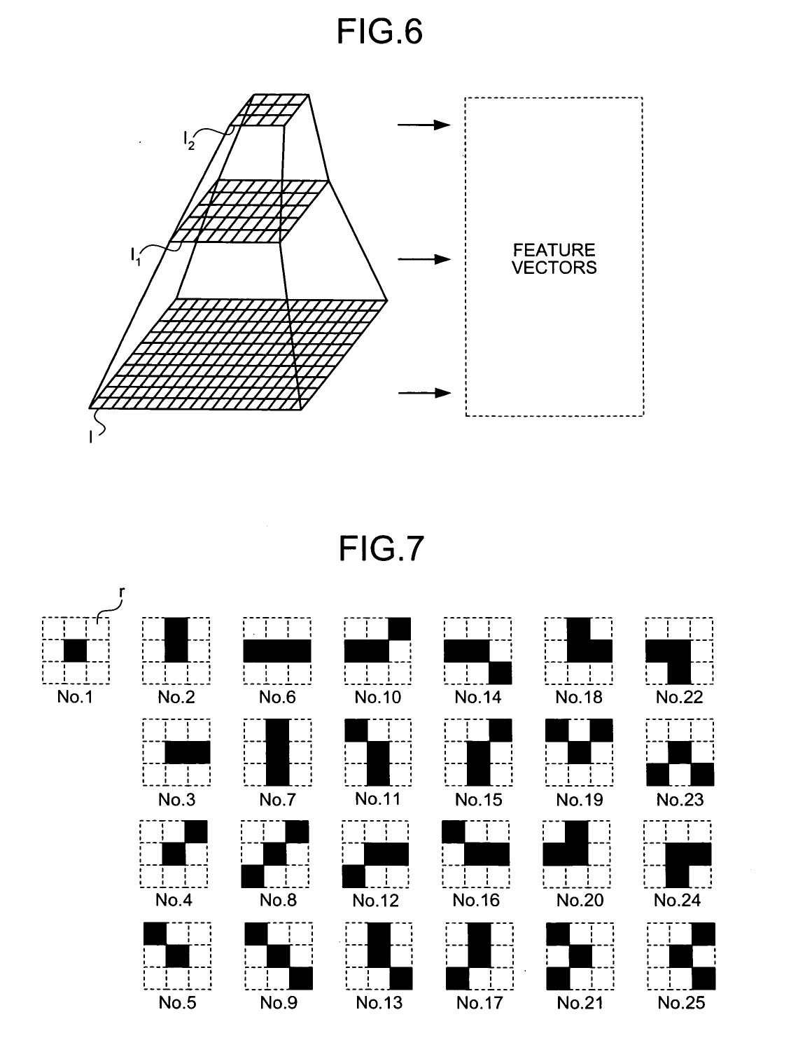

As shown in FIG. 5, first, an image I is generated by reducing an image of a block to be processed to that with a low resolution of about 100 dpi (step S11: an image generating unit), a threshold L for the number of resolution reductions is set (step S12), and a resolution-reduction count k is initialized (k←0) (step S13). The reason that the processes at steps S11 to S13 are performed is because, as shown in FIG. 6, features are extracted from the image I and also from images with lower resolution. The details thereof are explained later. For example, if the threshold L is set to 2 for the number of resolution reductions, three images of the image I, an image I, with a resolution of ½, and an image I₂ with a resolution of ¼ are obtained, and the features are extracted from the three images.

When the resolution-reduction count k does not reach the threshold L (YES at step S14), an image Iₖ(k=0, . . . , L) obtained by reducing the resolution to ½^{k} from the image I generated at step S11 is generated (step S15), and the image Iₖ is binarized (step S16: a binarizing unit). In a binary image, a black pixel is value 1 and a white pixel is value 0.

Then, an M-dimensional feature vector fₖ is calculated from the image Iₖ binarized with the resolution of ½^{k} (step S17), and then, the resolution-reduction count k is incremented by 1 (k←k+1) (step S18).

A method of extracting features from an image obtained by binarizing the image Iₖ (k=0, . . . , L) is explained below. An autocorrelation function is extended to a higher order (N order) to obtain a “higher-order autocorrelation function (N-order autocorrelation function)”, which is defined as the following equation with respect to displacement directions (S₁, S₂, . . . , S_{N}) where I(r) is an object image in a screen.

$${Z}^{N} ( {S}_{1} , {S}_{2} , … , {S}_{N} ) = {\sum }_{r} I ( r ) I ( r + {S}_{1} ) … I ( r + {S}_{N} )$$

Where a sum Σ is an addition of pixels r in the entire image. Therefore, it can be considered that there is an infinite number of higher-order autocorrelation functions depending on the order and the displacement directions (S₁, S₂, . . . , S_{N}) . However, for simplification, the order N of the higher-order autocorrelation function is up to 2 in this case. Furthermore, the displacement directions are restricted to a local region of 3×3 pixels around a reference pixel r. As shown in FIG. 7, the number of features is 25 as a total, for the binary image, excluding equivalent features obtained by parallel movement. Each feature is calculated in such a manner that a product of values of corresponding pixels in a local pattern is simply summed up for the entire image.

For example, the feature corresponding to the local pattern “No 3” is calculated by summing up products, for the entire image, each between a grey value at a reference pixel r and a grey value at a point adjacent thereto on the right side. In this manner, M=25-dimensional feature vector fₖ=(g(k, 1), . . . , g(k, 25)) is calculated from the image with a resolution of ½^{k}. Here, the function of the image-feature-amount calculating unit and the function of an adding unit are executed.

The processes (a feature-vector calculating unit) at steps S15 to S18 are repeated until the resolution-reduction count k incremented at step S18 exceeds the threshold L (NO at step S14).

When resolution-reduction count k incremented at step S18 exceeds (or is not smaller than) the threshold L (NO at step S14), the block is classified into any one of “picture”, “text”, and “other” based on the feature vectors f₀, . . . , f_{L} (step S19: a classifying unit).

A method of classifying the block is explained in detail below. First, a (25xL)-dimensional feature vector x=(g(0, 1), . . . , g(0, 25), . . . , g(L, 1), . . . , g(L, 25)) is generated from the M=25-dimensional feature vector fₖ=(g(k, 1), . . . , g(k, 25)) (k=0, . . . , L). To classify the block using the feature vector x of the block, previous learning is needed.

In the first embodiment, therefore, data for learning is classified into two types such as data with only characters and data without characters, to calculate respective feature vectors x. Thereafter, by averaging the respective feature vectors x, a feature vector p₀ of character pixels and a feature vector p₁ of non-character pixels are previously calculated. Then, the feature vector x obtained from the block image to be classified is decomposed into a linear combination of the known feature vectors p₀ and p₁, and combination coefficients a₀ and a₁ thereby represent respective ratios of a character pixel and a non-character pixel to the block, or indicate “likelihood of a character” or “likelihood of a non-character” of the block. The reason that such decomposition is possible is because the features based on the higher-order local autocorrelation do not change at object positions in the screen and have additivity for the number of objects.

The feature vector x is decomposed as follows:

x=a₀·p₀+a₁·p₁=F^{T}a+e

Where e is an error vector, F=[p₀, p₁]^{T}, and a=(a₀, a₁)^{T}. An optimal combination-coefficient vector a is given as follows using the least-squares method:

a=(FF^{T})⁻¹·Fx

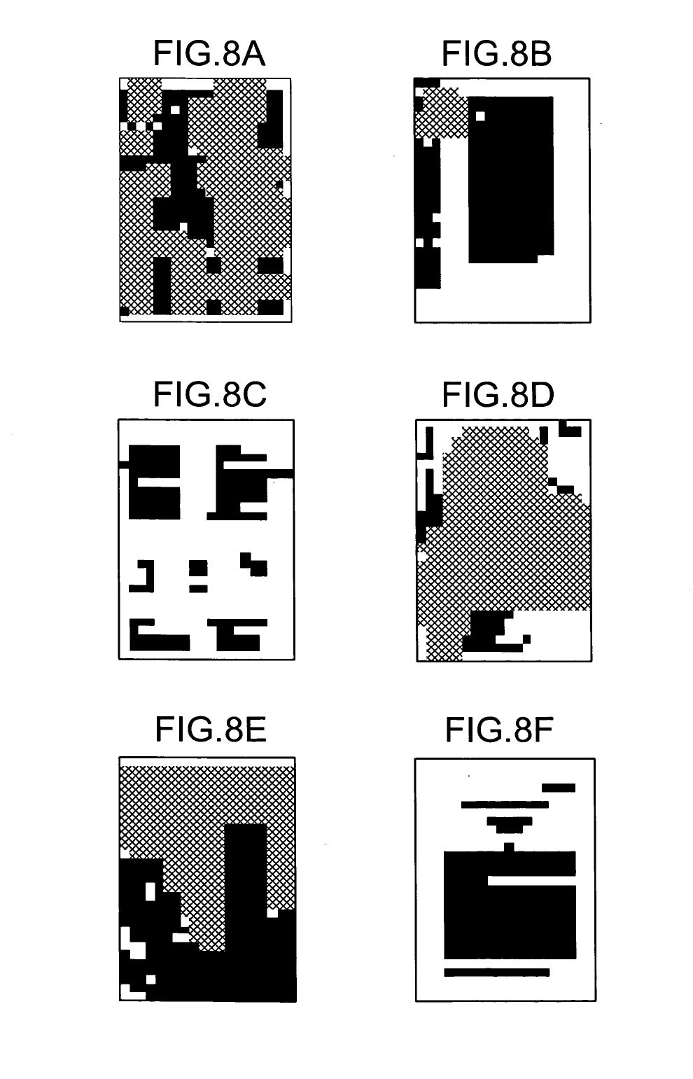

By performing a threshold process on a parameter a, indicating “likelihood of a non-character” for each block, the block is classified into “picture”, “non-picture”, and “unspecified”. If any block is classified into “unspecified” or “non-picture” and a parameter a₀ indicating “likelihood of a character” is a threshold or more, the block is classified into “text”, and if not, it is classified into “other”. Examples of block classification are shown in FIGS. 8A to 8F. In the examples of FIGS. 8A to 8F, the black portion represents “text”, the gray portion represents “picture”, and the white portion represents “other”.

(3) Calculation of Image Feature Amount (Step S3)

An image feature amount is calculated to separate images into types based on the classification result of the blocks. Particularly,

Respective ratios of text and picture to a block

Density ratio: How layouts are arranged (How densely layouts are arranged in a narrow portion).

Scattering degrees of text and picture: It is calculated how texts and photographs are scattered and distributed over paper. Specifically, the following five image feature amounts are calculated.

Text ratio Rtε[0, 1]: A ratio of a block (or blocks) classified into “text” to all the blocks.

Non-text ratio Rpε[0, 1]: A ratio of a block (or blocks) classified into “picture” to all the blocks.

Layout density Dε[0, 1]: A sum of the areas of the number of blocks classified into “text” and “picture” is divided by the area of a drawing region.

Scattering degree of text St(>0): Determinant of variance and covariance matrix of spatial distribution in x and y directions of a text block is normalized with the area of an image.

Scattering degree of non-text Sp(>0): Determinant of variance and covariance matrix of spatial distribution in x and y directions of a picture block is normalized with the area of an image.

Table 1 shows results of calculation of image feature amounts for the examples of FIGS. 8A to 8F.

TABLE 1

| | (a) | (b) | (C) | (d) | (e) | (f) |
|---|---|---|---|---|---|---|
| Percentages of | 25.2%, | 43.4%, | 26.4%, | 9.3%, | 48.3%, | 37.9%, |
| text and | 65.9% | 5.5% | 0.0% | 65.9% | 45.0% | 0.0% |
| photograph | | | | | | |
| blocks | | | | | | |
| Density | 94.3% | 71.0% | 30.5% | 75.2% | 96.9% | 63.8% |
| Dispersity of | 1.13, | 0.78, | 1.21, | 1.44, | 0.98, | 0.62, |
| text and | 1.24 | 0.07 | 0.0 | 0.96 | 0.86 | 0.0 |
| photograph | | | | | | |
| blocks | | | | | | |

The image-type identifying unit 23 classifies and identifies an image type using the image feature amount calculated by the image-feature-amount calculating unit 22. In the first embodiment, by using the feature amount calculated by the image-feature-amount calculating unit 22, a layout type of a document “which the bottom-up-type layout analysis is good at or which the top-down-type layout analysis is not good at” is more easily expressed by, for example, a linear discriminant function.

Layout type with mostly pictures and a few texts: layout type that satisfies the following determinant function such that Rp monotonically increases and Rt monotonically decreases.

Rp−a₀·Rt−a₁>0 (a₀>0)

### More specifically, a layout with a large photograph or picture, or a layout with many small photographs is classified into this type.

Layout type with low layout density (simple structure): layout type that satisfies the following determinant function such that D and Rt monotonically decrease.

−D−b₀·Rt+b₁>0(b₀, b₁>0)

More specifically, a layout not complicated and having a simple structure is discriminated as this type. The layout with a large picture or photograph causes the layout density to be high, and hence, this layout does not often the storage unit 26 in an associated manner, and any one of the region extraction methods may be selected according to the image type.

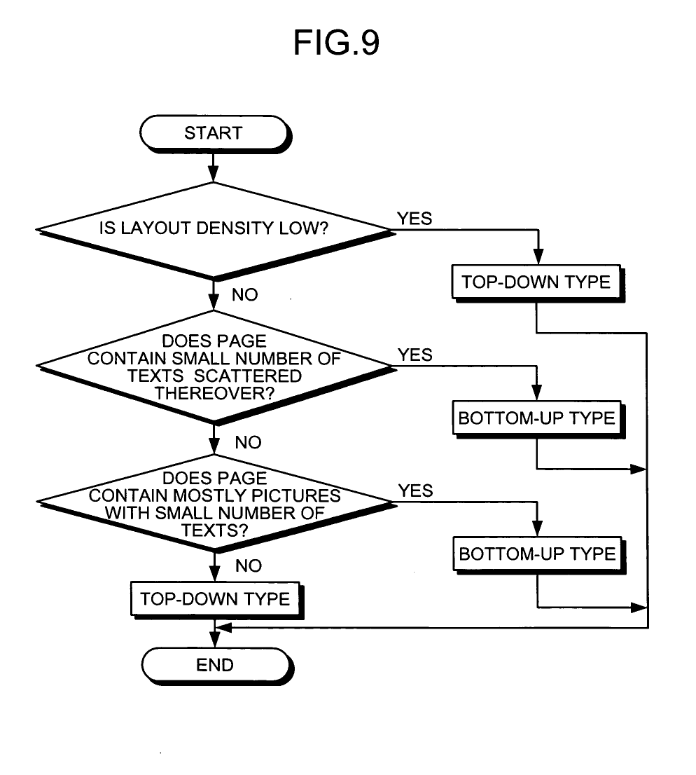

More specifically, in FIG. 9, when the layout is classified into the “layout type with low layout density (simple structure)” (corresponding to FIGS. 8C and 8F), the top-down-type region extraction method is selected. When it is classified into the “layout type with a few texts which are scattered over a page (non-structured document)” (corresponding to FIG. 8A), the bottom-up-type region extraction method is selected. When it is classified into the “layout type with mostly pictures and a few texts” (corresponding to FIG. 8D), the bottom-up-type region extraction method is selected. When it is classified into none of the layout types (corresponding to FIGS. 8B and 8E), the top-down-type region extraction method is selected.

Parameters are changed according to the region extraction method selected in the above manner. When a plurality of region extraction methods are to be selected, for example, priorities are given to the layout types, and the region extraction method for a layout type having the high priority is preferentially selected.

The region extracting unit 25 divides image data into regions based on the region extraction method selected by the region-extraction-method selector 24. appear in this type.

Layout type with a few texts which are scattered over a page (non-structured document): layout type that satisfies the following determinant function such that Rt monotonically decreases and St monotonically increases.

St−c₀·Rt−c₁>0 (c₀>0)

### More specifically, a layout, in which respective ratios of a photograph and a picture to the page are not so high but text accompanies each photograph or each picture, is classified into this type.

Table 2 shows examples of type identification for the examples of FIGS. 8A to 8F.

TABLE 2

| | Low | | |
|---|---|---|---|
| | layout | A few texts scattered | Mostly pictures and a |
| | density | over a page | few texts |
| (a) | | ◯ | ◯ |
| (b) | | | |
| (c) | ◯ | ◯ | |
| (d) | | ◯ | ◯ |
| (e) | | | |
| (f) | ◯ | | |

◯: [Document the bottom-up-type layout analysis is good at or Document the top-down-type layout analysis is not good at]

The region-extraction-method selector 24 selects a region extraction method for layout analysis based on the result of classifying an image into types in the image-type identifying unit 23. For example, the image types and the region extraction methods as shown in FIG. 9 are stored in

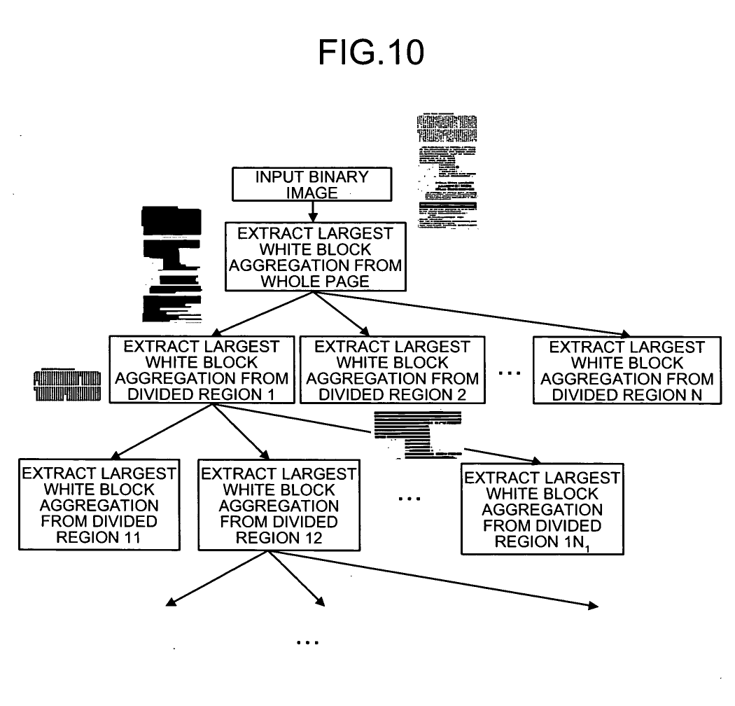

The layout analyzing process using the top-down-type region extraction method executed by the CPU 2 of the image processing apparatus 1 is briefly explained below. The image data, which is subjected to the layout analyzing process, is provided with a binary image skew-corrected without loss of generality, and a character is represented as black pixels. When an original image is a color image or a gray image, preprocessing for extracting a character by binarization is simply subjected to the original image. As shown in FIG. 10, basic approach of the layout analyzing process using the top-down-type region extraction method according to the first embodiment is implemented to achieve efficiency of the process by performing a hierarchical process based on recursive separation of density from low to high.

Roughly speaking, first, a lower limit being an end condition for extraction of at least one largest white block aggregation is set to a large value for the whole page, and the process is performed with a rough scale. At this stage, the white block aggregation(s) extracted is used as a separator to separate the page into some regions. Then, a lower limit being the end condition for extraction of at least one largest white block aggregation is set to a smaller value than the previously set value for each of the regions, and the largest white block aggregation(s) is again extracted to achieve finer separation. The process is recursively repeated. The lower limit, which is the end condition for extraction of the largest white block aggregation(s) in the hierarchical process, is simply set according to the size and the like of each region. In addition to the lower limit being the end condition thereof, restraint conditions on a desirable shape and size as the white block aggregation may be included in the process. For example, any white block aggregation which is not an appropriate shape as the separator for regions is excluded.

The reason that the block aggregation being an inappropriate shape as the separator for regions is excluded is because it is quite possible that a block aggregation whose length is short or whose width is too narrow is a space between characters. The restraint conditions for the length and the width can be determined according to the size of characters estimated within a region. The layout analyzing process using the top-down-type region extraction method is explained in detail in Japanese Patent Application No. 2005-000769 applied by the applicants of the present invention.

It is noted that the layout analyzing process using the top-down-type region extraction method is not limited by the above method.

On the other hand, the methods described in Japanese Patent Application Laid-Open Nos. 2000-067158 and 2000-113103 are applicable to the layout analyzing process using the bottom-up-type region extraction method, and hence, explanation thereof is omitted.

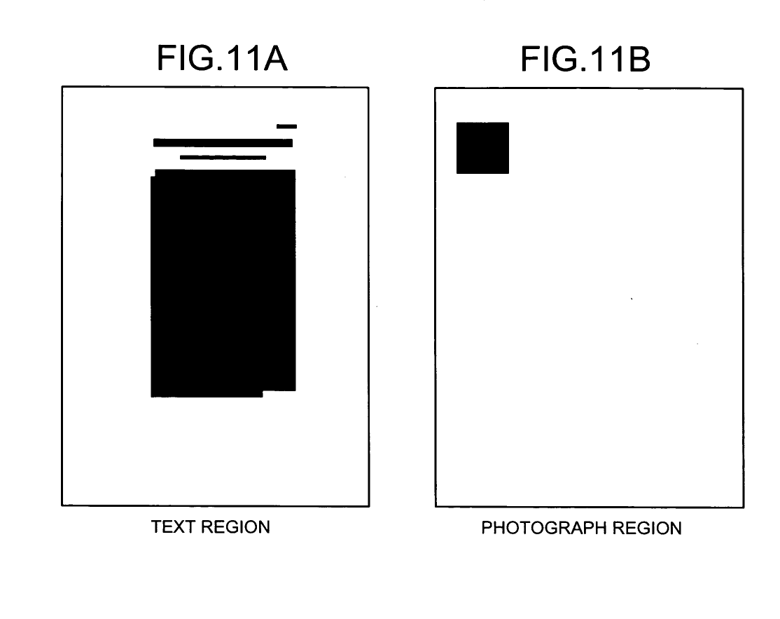

FIGS. 11A and 11B represent results of text region extraction and photograph region extraction, respectively, for an image shown in FIG. 8B by the layout analyzing process using the top-down-type region extraction method.

In the first embodiment, image data is classified to identify the type of the image data using the image feature amount of the image data calculated based on the layout (rough spatial arrangement and distribution of texts and photographs or pictures). Based on the result, a region extraction method associated with the type of the image data is selected for the layout analysis. The image data is divided into regions according to the region extraction method. This allows high-speed calculation of the image feature amount that characterizes the type of an image by following the outline of the layout (rough spatial arrangement of the texts and photographs or pictures and distribution thereof), and also allows selection of any region extraction method for the layout analysis suitable for the type of the image data. Thus, the performance of region extraction from an image can be improved.

In “(2) Classification of blocks (Step S2)” according to the first embodiment, a coefficient vector a that consists of coefficient components indicating “likelihood of a character” and “likelihood of a non-character” of a block is calculated, using a matrix F, for the (25xL)-dimensional feature vector x calculated from the block, but the calculation is not limited thereto. For example, “learning with teacher” may be previously performed using a feature vector x calculated from learning data and also using a teacher signal (which indicates a character or a non-character) accompanying the learning data, to structure an identification function. For example, as the learning and the identification function, existing data may simply be used. The existing data includes linear discriminant analysis and a linear discriminant function, and also includes error backward propagation of a neural network and a weighting factor of a network. As for the feature vector x calculated for a block to be classified, the identification function previously calculated is used to classify the block into any one of “picture”, “text”, and “other”.

The features are extracted from the binary image in “(2) Classification of blocks (Step S2)” according to the first embodiment, but the features may be extracted not from the binary image but from a multilevel image. In this case, the number of local patterns near 3×3 becomes 35. This is because totally 10 correlation values have to be calculated. More specifically, the 10 values include the square of a target-pixel gray value in the first-order autocorrelation, the cube of the target-pixel gray value in the second-order autocorrelation, and a product of the square of an adjacent-pixel gray value and a target-pixel gray value, the product being calculated for eight adjacent pixels. In the binary image, because the gray value is only 1 or 0, even if the gray value is squared and cubed, the values are not changed from their original values, but in the multilevel image, these cases should be considered.

In accordance with this, the dimension of the feature vector fₖ becomes M=35, and the feature vector fₖ=(g(k, 1), . . . , g(k, 35)) is calculated. Besides, (35xL)-dimensional feature vector x=(g(0, 1), . . . , g(0, 35), . . . , g(L, 1), . . . , g(L, 35)) is used for classification of the block.

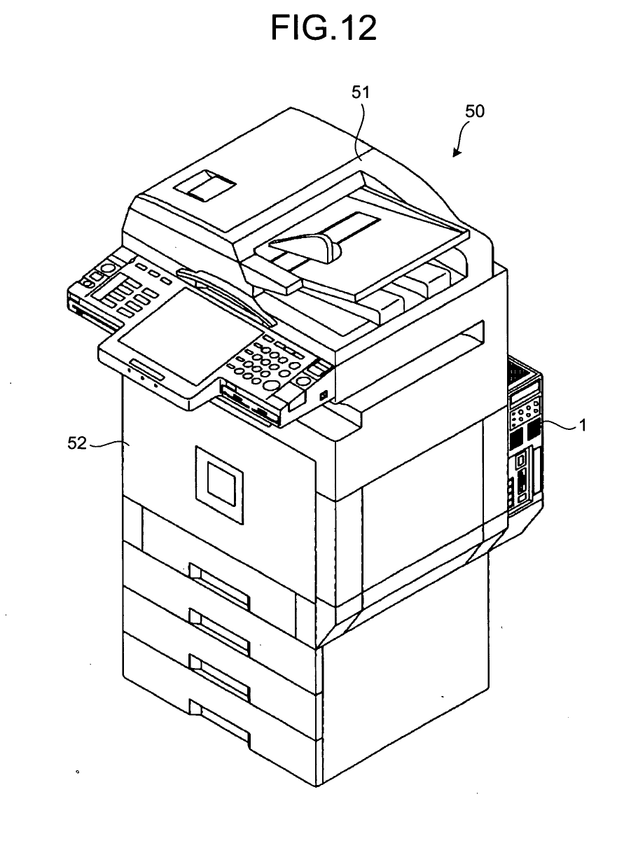

A second embodiment of the present invention is explained below with reference to FIG. 12. The same reference numerals are assigned to portions the same as these of the first embodiment, and explanation thereof is omitted.

In the first embodiment, the computer such as PC is used as the image processing apparatus 1, but in the second embodiment, an information processor installed in a digital multifunction product MFP is used as the image processing apparatus 1.

FIG. 12 is an external perspective view of a digital MFP 50 according to the second embodiment. The digital MFP 50 includes a scanner 51 being an image reader and a printer 52 being an image printer. The image processing apparatus 1 is used for the information processor included in the digital MFP 50 being the image forming apparatus, and the layout analyzing process is subjected to an image scanned by the scanner 51.

In this case, the following three modes are considered.

1. When an image is scanned in the scanner 51, the process is executed up to an image-type identifying process by the image-type identifying unit 23, and data is recorded in a header of image data as image type information.

2. When an image is scanned in the scanner 51, no process is executed, but the process is executed up to a region extracting process by the region extracting unit 25 upon data distribution or data storage.

3. When an image is scanned in the scanner 51, the process is executed up to the region extracting process by the region extracting unit 25.

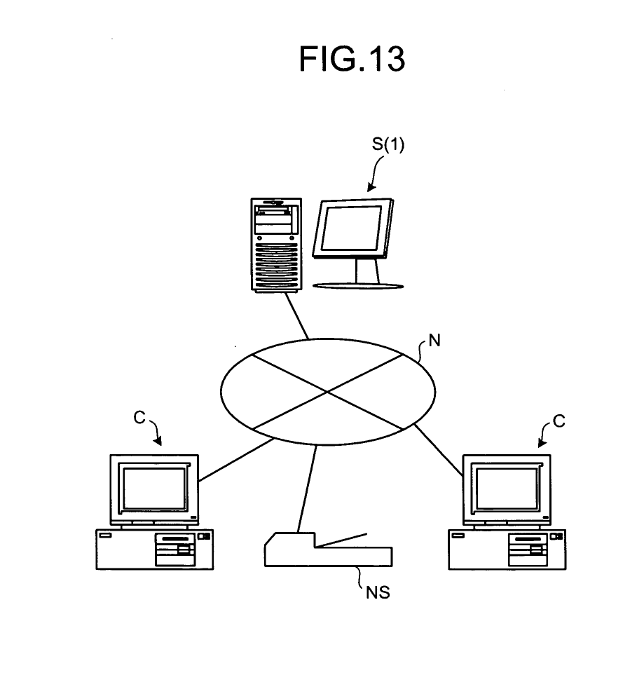

A third embodiment of the present invention is explained below with reference to FIG. 13. The same reference numerals are assigned to portions the same as these of the first embodiment, and explanation thereof is omitted.

In the first embodiment, a local system (e.g., a stand-alone PC) is used as the image processing apparatus 1, but in the third embodiment, a server computer forming a server-client system is used as the image processing apparatus 1.

FIG. 13 is a schematic of a server-client system according to the third embodiment. As shown in FIG. 13, the server-client system is adopted in such a manner that a plurality of client computers C are connected to a server computer S via a network N, and an image is transmitted from each client computer C to the server computer S (image processing apparatus 1), where the layout analyzing process is subjected to the image. It is noted that a network scanner NS is provided on the network N.

In this case, the following three modes are considered.

1. When an image is scanned in the server computer S (image processing apparatus 1) using the network scanner NS, the process is executed up to the image-type identifying process by the image-type identifying unit 23, and data is recorded in a header of image data as image type information.

2. When an image is scanned in the server computer S (image processing apparatus 1) using the network scanner NS, no process is executed, but the process is executed up to the region extracting process by the region extracting unit 25 upon data distribution or data storage.

3. When an image is scanned in the server computer S (image processing apparatus 1) using the network scanner NS, the process is executed up to the region extracting process by the region extracting unit 25.

As set forth hereinabove, according to an embodiment of the present invention, image data is classified to identify the type of image data using an image feature amount of the image data calculated based on the layout (rough spatial arrangement and distribution of texts and photographs or pictures). Based on the result, a region extraction method associated with the type of image data is selected for layout analysis. The image data is divided into regions based on the region extraction method selected. This allows high-speed calculation of the image feature amount that characterizes the type of an image by following the outline of the layout, and also allows selection of the region extraction method for the layout analysis suitable for the type of the image data. Thus, the performance of region extraction from the image can be improved.

Moreover, the outline of the layout such as the rough spatial arrangement of the texts and the photographs/the pictures and the distribution thereof can be acquired by each block. Thus, the image feature amount of the image data can be calculated in a simple manner.

Furthermore, rough and fine features of an image can efficiently be extracted, and highly expressive statistic information representing the local arrangement of black pixels and white pixels in the image data can efficiently be calculated. Moreover, classification of the image data according to distribution of the texts and the pictures (non-text) can easily be performed by linear calculation.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus that analyzes layout of an image, the image processing apparatus comprising:
an image-feature calculating unit that calculates an image feature amount of image data based on layout of the image;
an image-type identifying unit that identifies an image type of the image data using the image feature amount;
a storage unit that stores therein information on image types each associated with a region extraction method;
a selecting unit that refers to the information in the storage unit to select for layout analysis a region extraction method associated with the image type of the image data; and
a region extracting unit that divides the image data into regions based on the region extraction method.

2. The image processing apparatus according to claim 1, wherein the image-feature calculating unit includes
a dividing unit that exclusively divides the image data into blocks;
a block classifying unit that classifies each of the blocks as a component of the image data; and
a calculating unit that calculates the image feature amount based on a classification result obtained by the block classifying unit.

3. The image processing apparatus according to claim 2, wherein the block classifying unit includes
an image generating unit that generates a plurality of images with different resolutions from a block;
a feature-vector calculating unit that calculates a feature vector from each of generated images; and
a classifying unit that classifies each of the blocks based on the feature vector.

4. The image processing apparatus according to claim 3, wherein the feature-vector calculating unit includes
a binarizing unit that binarizes each of the generated images to obtain a binary image;
a pixel-feature calculating unit that calculates a feature of each of pixels in the binary image using a value of a corresponding pixel in a local pattern which is formed with the pixel and pixels surrounding the pixel; and
an adding unit that adds up features of the pixels in an entire generated image.

5. The image processing apparatus according to claim 3, wherein the feature-vector calculating unit includes
a pixel-feature calculating unit that calculates a feature of each of pixels in each of the generated images using a value of a corresponding pixel in a local pattern which is formed with the pixel and pixels surrounding the pixel; and
an adding unit that adds up features of the pixels in the entire generated image.

6. The image processing apparatus according to claim 3, wherein the classifying unit decomposes the feature vector into a linear combination of a feature vector of text pixels and a feature vector of non-text pixels previously calculated to classify each of the blocks.

7. An image processing method for analyzing image layout, comprising:
calculating an image feature amount of image data based on layout of an image;
identifying an image type of the image data using the image feature amount;
storing information on image types each associated with a region extraction method;
referring to the information to select for layout analysis a region extraction method associated with the image type of the image data; and
dividing the image data into regions based on the region extraction method.

8. The image processing method according to claim 7, wherein the calculating an image feature amount includes
exclusively dividing the image data into blocks;
classifying each of the blocks as a component of the image data; and
calculating the image feature amount based on a classification result.

9. The image processing method according to claim 8, wherein the classifying each of the blocks includes
generating a plurality of images with different resolutions from a block;
calculating a feature vector from each of generated images; and
classifying each of the blocks based on the feature vector.

10. The image processing method according to claim 9, wherein the calculating a feature vector includes
binarizing each of the generated images to obtain a binary image;
calculating a feature of each of pixels in the binary image using a value of a corresponding pixel in a local pattern which is formed with the pixel and pixels surrounding the pixel; and
adding up features of the pixels in the entire generated image.

11. The image processing method according to claim 9, wherein the calculating a feature vector includes
calculating a feature of each of pixels in each of the generated images using a value of a corresponding pixel in a local pattern which is formed with the pixel and pixels surrounding the pixel; and
adding up features of the pixels in the entire generated image.

12. The image processing method according to claim 9, wherein the classifying each of the blocks includes decomposing the feature vector into a linear combination of a feature vector of text pixels and a feature vector of non-text pixels previously calculated.

13. A computer program product for analyzing image layout, comprising a computer usable medium having computer readable program codes embodied in the medium that when executed causes a computer to execute:
calculating an image feature amount of image data based on layout of an image;
identifying an image type of the image data using the image feature amount;
storing information on image types each associated with a region extraction method;
referring to the information to select for layout analysis a region extraction method associated with the image type of the image data; and
dividing the image data into regions based on the region extraction method.

14. The computer program product according to claim 13, wherein the calculating an image feature amount includes
exclusively dividing the image data into blocks;
classifying each of the blocks as a component of the image data; and
calculating the image feature amount based on a classification result.

15. The computer program product according to claim 14, wherein the classifying each of the blocks includes
generating a plurality of images with different resolutions from a block;
calculating a feature vector from each of generated images; and
classifying each of the blocks based on the feature vector.

16. The computer program product according to claim 15, wherein the calculating a feature vector includes
binarizing each of the generated images to obtain a binary image;
calculating a feature of each of pixels in the binary image using a value of a corresponding pixel in a local pattern which is formed with the pixel and pixels surrounding the pixel; and
adding up features of the pixels in the entire generated image.

17. The computer program product according to claim 15, wherein the calculating a feature vector includes
calculating a feature of each of pixels in each of the generated images using a value of a corresponding pixel in a local pattern which is formed with the pixel and pixels surrounding the pixel; and
adding up features of the pixels in the entire generated image.

18. The computer program product according to claim 15, wherein the classifying each of the blocks includes decomposing the feature vector into a linear combination of a feature vector of text pixels and a feature vector of non-text pixels previously calculated.
